(19) United States
(12) Patent Application Publication
(10) Pub. No.: US 2023/0267411 A1
(43) Pub. Date: Aug. 24, 2023

(54) AUTONOMOUS SUPPLY ROOM

(71) Applicant: Shamrock Supply Company, Inc., Anaheim, CA (US)

(72) Inventors: Michael John O'Connor, Ladera Ranch, CA (US); Marc T. Redoutey, Costa Mesa, CA (US); Michael J. DeVoney, Cornelius, NC (US)

(21) Appl. No.: 18/174,486

(22) Filed: Feb. 24, 2023

Related U.S. Application Data
(60) Provisional application No. 63/313,384, filed on Feb. 24, 2022.

(51) Int. Cl. G06Q 10/087; G06V 20/52; G06V 40/20; G06V 40/16; G06T 7/20; G01G 19/52

(52) U.S. Cl. CPC G06Q 10/087; G06V 20/52; G06V 40/20; G06V 40/172; G06T 7/20; G01G 19/52; G06T 2207/30196; G06T 2207/30232

(57) ABSTRACT

An autonomous supply room includes an enclosure, a computer dispensing system, and one or more processors. The enclosure includes a secure entryway configured to provide access to a user into the enclosure based on a user characteristic; and at least one storage shelf within the enclosure. The computer dispensing system includes a sensor integrated to the storage shelf, the sensor configured to detect addition or removal of items to or from the shelf and to transmit one or more signals indicative of detecting addition or removal of items; and one or more cameras configured to track movement of the user within the enclosure. The one or more processors are configured to receive the signals from the sensor and tracking information from the camera, identify one or more items taken from the at least one storage shelf by the user, based on the one or more signals from the sensor and on the tracking information from the camera, and transmit, to an inventory management system, information identifying the user and the items taken from the at least one storage shelf.

### INCORPORATION BY REFERENCE TO ANY PRIORITY APPLICATIONS

This application claims the benefit of U.S. Provisional Application Ser. No. 63/313,384, filed Feb. 24, 2022, entitled “AUTONOMOUS SUPPLY ROOM,” the entirety of which is incorporated by reference herein. Any and all applications for which a foreign or domestic priority claim is identified in the Application Data Sheet as filed with the present application are hereby incorporated by reference under 37 CFR 1.57.

### TECHNICAL FIELD

This disclosure relates to systems and methods for an autonomous supply room, and more specifically to inventory management and materials management hardware and software tools to provide an automated inventory process.

### BACKGROUND

Conventional supply rooms and inventory systems suffer from exceedingly high operating expense per transaction, chiefly in labor expense. Further, conventional approaches that do not require a high labor quotient fail to deliver accurate inventory counts and transactional data.

### SUMMARY OF THE INVENTION

In a first aspect of the present disclosure, an autonomous supply room includes an enclosure, a computer dispensing system, and one or more processors. The enclosure includes a secure entryway configured to provide access to a user into the enclosure based on a user characteristic; and at least one storage shelf within the enclosure. The computer dispensing system includes a sensor integrated to the storage shelf, the sensor configured to detect addition or removal of items to or from the shelf and to transmit one or more signals indicative of detecting addition or removal of items; and one or more cameras configured to track movement of the user within the enclosure. The one or more processors are configured to receive the signals from the sensor and tracking information from the camera, identify one or more items taken from the at least one storage shelf by the user, based on the one or more signals from the sensor and on the tracking information from the camera, and transmit, to an inventory management system, information identifying the user and the items taken from the at least one storage shelf.

### BRIEF DESCRIPTION OF THE DRAWINGS

In the drawings, which are not necessarily to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of an autonomous supply unit and internal components according to some embodiments.

FIG. 2 is a top cutaway view of an autonomous supply unit according to some embodiments.

### DETAILED DESCRIPTION

Embodiments of autonomous supply rooms are disclosed herein. Although certain illustrative embodiments are shown in the drawings and will be described below in detail, the claims are not limited to these embodiments. However, there is no intention to limit the disclosure to the specific embodiments disclosed. On the contrary, the intention is to cover all modifications, alternative constructions, combinations, and equivalents falling within the spirit and scope of the disclosure and defined by the appended claims.

Disclosed herein are embodiments of a supply room that may be automated for inventory control that may be used, for example, in scenarios where an unattended business or environment is desired. Examples of such scenarios include, for example, supply management for raw materials and/or industrial use materials at facilities in the manufacturing sector, management of consumables and/or other supplies for the governmental sector (e.g., consumables and/or other supplies used by federal, state, and/or local governments for public works or other departments, such as water departments, park systems, police, road maintenance, fleet maintenance, facilities maintenance, or other applications), storage and distribution of materials in the medical sector (e.g., medical supplies, personal protective equipment, pharmaceuticals, or the like), supply management for facilities management and/or hospitality services (e.g., facilities maintenance, hospitality, and/or food service products for large institutions or campuses), and/or supply management for the energy and/or construction sectors. In another such scenario, the systems and methods described herein can be applied to various retail applications where the benefits of an attendant-free sales environment might be realized. Certain embodiments of the present disclosure substantially eliminate the labor expense associated with conventional approaches while also providing highly accurate inventory and transactional data.

Some embodiments may provide the use of artificially intelligent programs, computer vision systems, and other sensors to determine what materials have been removed from its shelves, and by whom. No full-time human attendants, cashiers, warehousemen, or storekeepers may be required. The uniquely assembled and programmed components of the systems described herein may create a secure automated environment for issuing and replenishing inventory. Methods may be used to track inventory both from and to the secure environment. In certain embodiments, accounting features may be implemented that meet the needs of a typical business-to-business supply relationship for invoicing and reporting purposes.

In some embodiments, determination of which items have been removed from shelves may be accomplished primarily or entirely based on signals from weight sensors disposed in the shelving units. For example, in contrast with retail settings in which products frequently have easily recognizable graphics and/or colors that permit easy identification of items by computer vision, products in a supply room setting may not be easily differentiable on the basis of packaging. For example, different sizes or weights of similar items may share a substantially similar packaging differentiated only by text which may be too small for distantly located cameras to distinguish. Accordingly, the specific type of product removed from a shelf may be accurately determined based on a change in weight detected by a weight sensor on the shelf. The determination that a particular product has been removed may be confirmed based on, for example, a computer vision determination that a particular user is in the vicinity of the shelf or that the user is holding an item having an appearance consistent with the removed item.

Some embodiments may provide the advantage of a frictionless, attendant-free, or cashier-less wholesale business-to-business product sales environment. Some embodiments may meet the needs, for example, of an industrial use, business-to-business supply room management environment. The system may provide industrial customers with an accurate and unattended inventory management tool for the provision of indirect materials, including maintenance, repair, operations (MRO) supplies, office supplies, critical spare parts, and production-related consumables. The systems and methods described herein can be applied to a wide variety of applications such as business-to-business and governmental sales relationships. More specifically, the systems may be applied to end-market customer applications that might include, but are not limited to: public/investor-owned utilities; power generation; manufacturing; processing plants; food and beverage; hospitals/healthcare; public safety/police; mining; hospitality; government; entertainment; consumer and pharmaceuticals; first responders; aerospace; construction; oil/gas industry.

Some embodiments of an autonomous inventory system may eliminate error in inventory tracking. With complete autonomy of the system, delays to reordering or restocking may be eliminated, as well as those human errors associated with mispricing or mischarging. Reports may be automatically and regularly generated for administrators or users to review.

While several embodiments are disclosed below, the inventory unit may be customized to fit the needs of the supplier or administrator. For example, the type of unit installed, as well as the components within, can be outfitted depending on the type of inventory being stored. Several embodiments of an autonomous supply room are possible by the addition of different features or components. According to some example embodiments, various sizes and types of pre-engineered secure enclosures may be designed to house specific numbers of cameras, shelving units, shelves, or a predictable range of standard industrial products. Some of the components are described below with respect to the figures. However, more details of alternative or additional components are described in the paragraphs below.

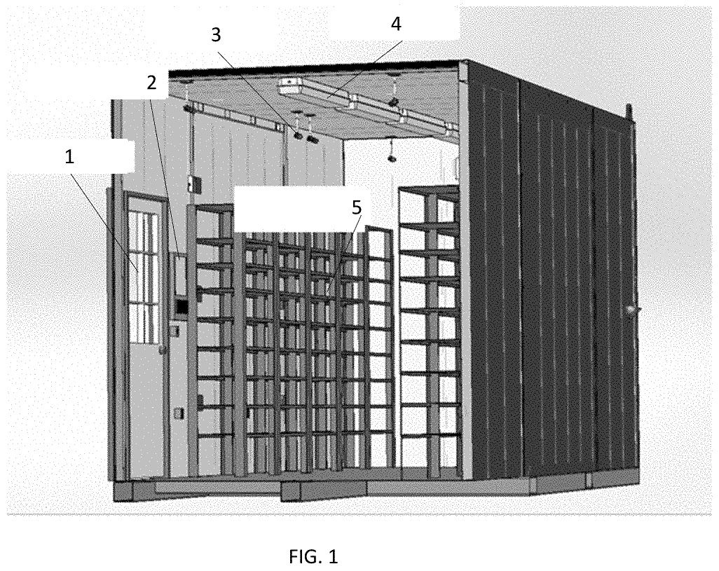

FIG. 1 is a representative perspective view of an embodiment of an autonomous supply room. The supply room may have an interior space enclosed by a set of walls creating a secure enclosure. The secure enclosure may be a small building, room, a container such as a modified shipping container, or any other suitable structure. Access into the interior space of the secure enclosure may be controlled by a secure entryway 1. In some embodiments, the secure entryway 1 may be a door or other opening having electronically controlled locking, unlocking, opening, and/or closing functions. The secure entryway 1 may be locked at all times to keep the inventory space secure. Unlocking and/or opening the secure entryway 1 to enter the secure enclosure may be controlled based on the credentials or status of the individual attempting to enter.

In some embodiments, the secure entryway is an electronically controlled doorway or other physical entry barrier. The secure enclosure may also be a mesh enclosure such as a five-sided welded wire mesh enclosure, various types of fencing, a secure room, or a specially designed secure stand-alone trailer or modified shipping container.

In certain embodiments, the secure entryway may be a door, gate, or other device to limit entry to validated users of inventory unit. Systems in communication with the inventory unit may work to validate the user requesting entry, discussed below in more detail. Users may gain access to begin a shopping session through an electronic signal. In some embodiments, access is granted via a facial recognition system, a voice recognition system, cardkey reading systems, keypad coded entries, and/or biometric identification systems such as a fingerprint scan, retinal scan, or DNA reader. A table of valid users, and/or of records indicating when a user is validated, may be maintained. As will be described in greater detail, a user may be tracked throughout the shopping process, charging the user's account for anything taken by the user during the shopping session.

In some embodiments, within the secure enclosure, there may be a computer or touchscreen tablet 2 or other user interface device to access information about the inventory space and experience. The touchscreen tablet 2 may be located in an area next to the secure entryway 1. User-specific information may be available and displayed on the touchscreen tablet 2 or other user interface device.

Within the secure enclosure, inventory or products may be organized on shelving units 5. The shelving units 5 may be smart storage space to allow electronic monitoring of the contents within. For example, the shelving units may have scales or other weight sensors integrated in order to detect the addition or removal of items to and from the individual shelves of the shelving unit and/or to calculate the weight of items moving on and off the shelves. There may be a plurality of shelving units 5 around the secure enclosure spaced to allow an individual or user to move comfortably between the units. Shelving units 5 may only be tall enough so that an average height human may reach items from the top. In alternative embodiments, the secure enclosure may be fitted with shelving, cabinets, pallet racks, shelf bins, or other storage containers.

In some embodiments, the top of the secure enclosure may have lights 4 (e.g., an LED luminaire or other lighting device) installed that may be turned on and off upon entry by a user. The lights 4 may be kept on at all times. Alternatively, the lights may be toggled on automatically when a user enters the secure enclosure then automatically turned off after a set period of time. Additionally, the lights may be controlled by a motion sensor and may turn off when no further motion is detected within the secure enclosure, or may be manually controllable by a switch.

In certain embodiments, the secure enclosure may also be fitted with cameras 3 on the ceiling, the walls, and/or on the contents within the enclosure. Cameras 3 allow monitoring of users and/or inventory within the secure enclosure. Cameras 3 may be in communication with software to track inventory moving in and out of the secure enclosure and/or to track the movements of individual users within the secure enclosure.

In some embodiments, several of the components within the secure enclosure may be in communication with a software or cloud-based monitoring system. Each of the components within the system may communicate with a process to work together in creating the autonomous inventory unit. In one embodiment, the Computer Vision Dispensing System (or “Vision System”) can be a sophisticated array of cameras, shelves with integrated scales, and various processors. The components may work in tandem to monitor inventory on shelves within the enclosure, which, through various artificially intelligent algorithms, can determine which materials have been taken or replenished by specific users within the system. While the Vision System may not require human intervention, the system may manage inventory levels to a high degree of accuracy. The Vision System may include on-premise servers for high capacity processing of images, spatial location, and machine learning software. The Vision System may also include a high-speed internet connection and a cloud-based processing format. In lieu of ethernet connection, the Vision System may also utilize various wireless protocols, such as 5G cellular internet service or other wide area wireless systems. The Vision System may integrate various product identification signals, including signals indicative of or related to various physical characteristics of the products such as, but not limited to, images of the products themselves, a three-dimensional product location module that confirms the location of products, the changes in weight as products are added or taken from the shelving, and signals indicative of or related to the behaviors and activities of the shoppers in the environment. The Vision System may be loaded with a three-dimensional model of the storage equipment and components to allow a virtual model to be built within the system.

In certain embodiments, an inventory system may receive information from the Vision System to track contents within the secure enclosure. For example, an Inventory Management and Procurement System (or “Inventory System”) may receive inventory change data from the Vision System, linking the inventory change to a particular user, then billing the user for materials taken. The Inventory System may also automatically reorder materials from designated suppliers through an online order process. In some embodiments, the online order process may be formatted in Extensible Markup Language (XML). The Inventory System may also be configured with various inventory management parameters per stock item, such as reorder points, minimum quantity levels, maximum quantity levels, designated suppliers, and pricing. Management parameters may be set or adjusted by an administrator of the integrated systems. Additionally, the Inventory System may be able to process receipts for materials delivered by suppliers, provide cycle-counting, or other inventory accuracy routines to correctly report consumption and quantities currently on-hand. In some embodiments, the Inventory System may be applied as an industrial vending solution.

In some embodiments, the touchscreen tablet 2 or other interface device may provide access to a Shopper User Interface (“SUI”). The SUI may be in communication with the Inventory System and the Vision System to provide updated information to entrants. For example, when a user enters the secure enclosure, the SUI may provide shopping subroutines based on the proximity of the closest user to the tablet. Alternatively, a user can use the SUI to locate an item within the supply room, confirm the user company's cost accounting information necessary for proper invoicing, or confirm that the products and quantities in a shopping cart are correct. The shopper may use the SUI to indicate that they are checking out of the supply room which will reopen the electronically controlled gate (or doorway) for egress. In some embodiments, the secure entryway may not be unlocked for either ingress or egress until identity of the user is verified and/or the shopping experience has been completed.

In some scenarios, the secure entryway may be locked while the user is within the enclosure, and the secure entryway may be unlocked again in response to the user completing the checkout process. For example, egress may not be permitted from the secured enclosure if the user has not completed checkout or has chosen items outside their privileges. For example, a user may only be allowed to take certain items from inventory at the end of their shopping experience. When the user enters the secure enclosure, using any of the credentials described herein, the system may identify the user and a corresponding category, access level, hierarchy status, or other group or categorization corresponding to the user. The corresponding group or categorization may be associated with a predetermined set of privileges, such as a subset of stored items, maximum numbers of individual items, etc. In some cases, the number of items or number of an individual type of item that the user is allowed to take may be determined on a case-by-case basis, such as in accordance with an inventory management scheme based on a limited or predicted available amount of the individual type of item. If the user has selected more than what the system has instructed or allowed, the secure entryway may not unlock, and the user may be instructed to return unpermitted inventory to the shelves.

In certain embodiments, the Computer Vision Dispensing System, the Inventory Management and Procurement System, the Shopper User Interface, and other components within the inventory unit may work together under a single “System.”

In further embodiments, robots may be implemented into the inventory unit. Robots may be built and programmed for various capabilities (e.g., a pick-and-place robot) and may be used within the supply room to select, transfer from one location to another, or provide inventory items to a user. For certain applications, it may be advantageous to limit access to certain supply rooms, or portions of a supply room, to robots only where users of the supply room are prohibited from entry.

In another embodiment, drones having various capabilities may be used within the inventory unit. Drones may be implemented, for example, to select, transfer from one location to another, or provide inventory items stored in the supply room to a user. For certain applications, it may be advantageous to limit access to certain supply rooms, or portions of a supply room, to robots only where users of the supply room are prohibited from entry.

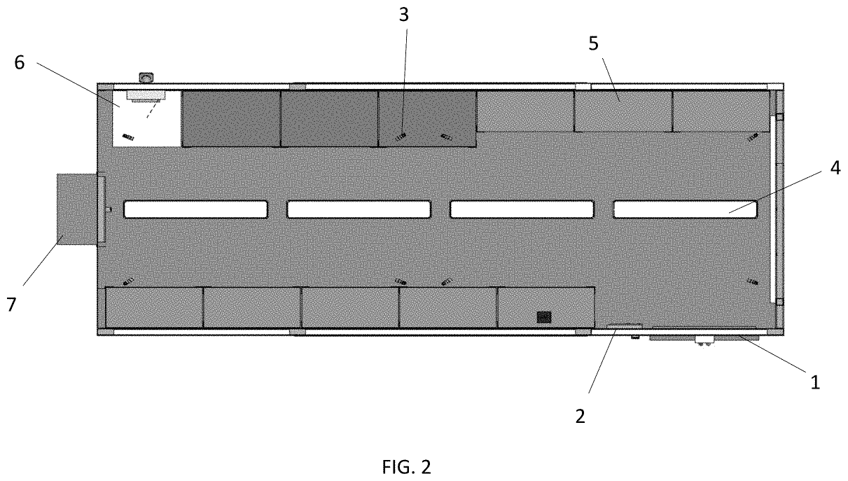

FIG. 2 is a top cutaway view of the embodiment of an autonomous supply room as depicted in FIG. 1. From the top view, the secure entryway 1 may be positioned by the touchscreen tablet 2 near the only entry point of the enclosure. In this embodiment, two sets of shelves 5 may line the long edges of the enclosure. The enclosure may be large enough for a user to comfortably move between the shelves 5. A lighting system including lights 4 is designed to illuminate the enclosure at least while one or more users are present within the room, and may be activated when a user enters. In some embodiments, a plurality of cameras 3 are positioned within the enclosure to ensure that both users and inventory are consistently monitored. The inventory unit may have a server 6 for collecting data and information from the cameras, shelves, entryway, tablet, or other components to send to a processor for analysis. The secure enclosure may also be fitted with a heating, air conditioning, or ventilation unit 7 to ensure the environment within is comfortable for users.

### Example Method of Operating an Inventory Unit

An example method will now be described for operating an inventory unit, such as an autonomous supply room as described herein. The following method is merely a single non-limiting example, and it will be understood that the systems of the present disclosure may equally be operated in accordance with other methods including more, fewer, or different operations than those described below.
1. A supply room user, such as a shopper or supplier representative, provides credentials to the System. The System confirms that a valid entry has been requested, permits access by opening the doorway, then initiates the shopping session or supplier replenishment session.
2. The Vision System follows the user throughout the shopping session, analyzing the user's activities, and calculating the correct products and quantities taken by the user to increase or decrease on-hand quantities within the Inventory System. In some embodiments, the products and quantities taken by the user can be determined based primarily or entirely on signals received from the weight sensors in the shelving units. For example, the products taken may be identified based on matching a decrease in weight detected by a weight sensor with a known unit weight or multiple of a known unit weight, corresponding to an item known to be stored on the shelf. The identification of the product taken may be confirmed in conjunction with the Vision System, for example, by confirming that the user was in the vicinity of the shelf when the change in weight occurred. The Shopper User Interface touchscreen tablet may be used to look up item locations and shelf quantities as an aid to the shopping process.
3. The Shopper User Interface provides a rationing (or reduced consumption) function by displaying the user's month-to-date consumption and comparing this to the user's month-to-date spend budget. Budget transparency creates greater adherence to the budget and reduces the chance of over-consumption.
4. Upon completion of the shopping process the user may use the Shopper User Interface to confirm the order as calculated by the Vision System. The user may also confirm that the correct customer-defined accounting codes are being applied to the order or the items within the order.
5. According to an example embodiment of the disclosure, the user positively closes out the session through an interaction with the Shopper User Interface such as pressing a “Checkout” button. This action closes the order and unlocks the entryway for egress by the shopper after shopping is completed. The System continues to monitor if any other items are removed by the shopper, which would start a new shopping session. The entryway is relocked after a short period of time. The system sends an email receipt of the materials that have been accounted to the shopping session to the user or their proxy.

The user may, according to another example embodiment of the disclosure, dispute the order as calculated by the system upon receipt of the confirmation email. The user may dispute the emailed receipt by, for example, pressing a button embedded in the email which is labeled “dispute”, or by calling the administrator. The user then describes the discrepancies that caused the dispute. A remote administrator will then review the dispute and audit the video of the shopping session to confirm or deny the claim of the shopper, changing the order if the client's dispute was confirmed.

The system according to some example embodiments may provide a detailed periodic cost accounting report based on the shopper's checkout process and the supplier's agreement for periodic invoicing (e.g., weekly, monthly, etc.). Some of this cost accounting information may be preloaded in the virtual shopping cart based on such things as the user profile or a departmental code, or it can be associated with the product being used (i.e., a janitorial item might have a different accounting code than a facilities item). Based on the client business accounting requirements, the Shopping User Interface and the Inventory System can be configured with a combination of preloaded accounting data, drop down menus for accounting data, or free text accounting data entered by the shopper on the touchscreen tablet. Machine learning routines allow the Shopping User Interface to predict default accounting codes for the shopper. After this stage of the process, accurate and customized accounting fields are associated with the order so that internal expensing (or budgetary cost accounting) of the materials can be achieved simply and effectively. This data can also be presented as a summary invoice, detailing all aspects of the transactions included during the defined period of the invoice. Depending on whether the inventory on hand is supplier-owned or customer-owned, the individual shopping transactions for these items would be invoiced directly (as supplier consigned inventory) or indirectly upon replenishment order receipt.

In some embodiments, the Inventory System frequently (and in some embodiments, constantly) monitors the inventory levels of all products in the supply room, suggesting replenishment orders based on order points, min/max levels, and other inventory parameters managed by the system administrator. The Inventory System can be set to automatically order replenishment items from an unlimited number of predesignated suppliers, or the system can be set for administrative review prior to sending orders. The replenishment process may apply to supplier owned (consignment) inventory as well as customer owned inventory. These two types of inventory are accounted for separately in the Inventory System, and can apply to different quantities of the same item. The Inventory System utilizes, for example, standard XML business documents for procurement transactions and invoicing, but can be set to send HTML order documents by email to the supplier. The supplier representative will deliver the ordered quantities when available, initiating a supplier session in the supply room. The system will recognize the user as a supplier replenishing inventory, allowing the supplier to confirm quantities delivered and delivery documentation as necessary to establish an audit trail through the replenishment transaction and the Shopper User Interface. The receipt transaction may also be confirmed by the administrator.

The shopper may choose to return surplus or unneeded items well after the shopping session is completed. The Inventory System allows for the administrator to process returns and credits after reviewing the returned products for salability. The shopper, for example, may request the return by email and then places the returned goods in a secure drop box located just outside of the Secure Enclosure, or in another suitable location.

The administrator, in conjunction with shoppers and suppliers, can adjust inventory quantities up or down based on feedback identifying on-hand shortages found during the shopping process, the replenishment process, or the cycle-counting process. The Inventory System provides an audit trail for adjustments made to the on-hand quantities under this circumstance.

Alternative methods and scenarios may be possible when using an automated inventory unit or supply room. For example, a user may approach the secure enclosure needing to obtain inventory for a specific department. Upon scanning a badge or using biometric data, the secure entryway may permit the user into the secure enclosure. The System may communicate the user's role and department and tie the user to a specific account. At entry, the touchpad screen may present information to the user regarding permissible items within a certain budget. The user may navigate the shelving units and take items as needed. Shelves may have an integrated sensor, such as scales for weighing the amount of items on the units, and will communicate a signal to a processor when items are removed from the shelves. Calculations are performed in the processor to determine what type or how much of an item is removed from the shelves. Cameras positioned within the enclosure may monitor the user throughout the experience including items the user selects from the shelves. Once items are selected, the user may verify with the touchscreen the type, quantity, and price of items taken. If the checkout process matches with the System, the secure entryway may be unlocked and the user permitted to leave. The shopping experience may be ended and the System may charge a particular profile, account, or department for the items taken. Inventory changes may be logged within a database and any ordering or replacement processes may initiate.

The inventory unit and shopping system may be configured with a minimum operating system and functionality to enable full use of the included components. Several embodiments of the minimum operating functionality are disclosed below, but other embodiments are possible.

### Dispensing Process

When identifying the user, the supply room shopping system (the “System”) can accommodate a number of unique user profiles per supply room as required by a particular application. In an example embodiment of the disclosure, the system is capable of supporting at least 1,000 unique user profiles per supply room. An administrator can add or subtract users from the validated user profile table. User profile information may be shared from the Inventory System to the Shopper User Interface as necessary. The supply room will selectively allow access to those users whose identification credentials are current. The System may allow the administrator to set up user profiles with specific spend limits, product category authorization, and supply room access. The System may allow the administrator to set limits on the total amount in dollars purchased by a user (or user type) per time period, with an optional setting to disallow access when such limits are exceeded.

In some embodiments, the Vision System can track the activity of at least two users simultaneously in the supply room. Tracking capability may be scalable as the size of the supply room is increased or decreased. In one particular example, with supply rooms larger than 100 square feet, the System may be able to track at least one additional user per 100 square feet. An individual supply room may have a predetermined number of users allowed to occupy the room simultaneously, determined based on the size of the room and on the number, location, orientation, and/or capabilities of the cameras and associated computer vision systems.

In some embodiments, approved users can sign into the Inventory System remotely for example, from either mobile devices or a PC. The user can create and edit a “hot list” document, from which they can initiate an order prior to their arrival at the supply room. A hot list may be a list of regularly purchased items that the user predefines and is used to check inventory prior to their arrival. Hot lists may speed up the dispensing process once users arrive at the supply room. The System may add further information to a hot list document, for example, by defaulting to zero quantity for items on the list to start an order and adding quantities to the items as they are taken by the user within the supply room. Working from either a remotely created hot list or a new order session in the System, the user is able to identify the location and quantity on-hand of the required product based on a search for that product from a mobile device or through a permanent crib-based Shopper User Interface (or “SUI”, typically a mounted touchscreen tabular device). In some embodiments, the search process to identify a product and product location allows for string searches initiated by the user that may include such attributes as manufacturer's name, product “key word”, manufacturer's product number, customer's product ID number, and product taxonomy (e.g., logical category and subcategory).

### Customer Checkout Process

In some embodiments, the System may present each shopper with a confirmation of their order prior to checking out of the supply room. Upon checkout, all items, quantities (including the relevant unit of measure), and total dollar values are presented to the user for their review on the SUI. Should a user dispute any System-generated item or quantity information, the user can indicate the nature of the dispute prior to checkout so that an administrator can resolve the disputed information later; in the short term the user will be charged for the quantity and product as shown; the user can also register a dispute through the emailed receipt document sent after leaving the supply room. If the administrator has placed spend or transactional limits upon the user, the System will advise the user when the limit has been exceeded, and by how much, disallowing checkout until the order is within established limits (e.g., until the user returns the items exceeding the limit to their stock locations as verified by computer vision and/or other sensors). The user has the right to stop the checkout process and remove items from their order session, replacing unwanted items to the appropriate shelf and thereby reducing their total order amount. Alternatively, the administrator may give the System approval to override the user's established limit for that session, or to increase the limit for the user's profile during that session, effectively releasing the order.

In some embodiments, the System may require that cost accounting information be confirmed or provided by the user (the conditionality is based upon customer configuration requirements). Such cost accounting information may be configurable by supply room/client requirement, and may include, for example, at least fields to accommodate appropriate codes such as a plant code, department code, general ledger accounting code, machine code, and the possibility of a work order or project code, and/or other fields as appropriate according to the scenario in which the supply room is implemented. When possible these codes are presented in dropdown menu format, with any required fields established by the administrator and highlighted for the user; some or all of the cost accounting information may be hardcoded at the product code level if the client determines that an item will always be accounted for in the same way; some or all of the cost accounting information may be hardcoded under the user's profile. Cost accounting information may be then transmitted to the Inventory System with all other transactional information on a per item basis.

Upon satisfaction of the above requirements, the System allows the user to exit the secure environment with their confirmed items and close out the order, reducing shelf inventory and adding the new order to a transaction report for expense and/or billing purposes. The System then sends a final receipt to the user or the user's proxy by email as soon as the order is completed.

### Reconciliation of Disputes, Returns, and Shortages

Whenever a shortage, return, or System error results in the need to correct on-hand inventories, the site administrator has the ability to make inventory adjustments from a remote location. For disputed items, users may choose to dispute the System's finding of quantity or product code taken from the supply room either upon checkout or within a specified number of hours after checkout by replying to the emailed receipt document that they received; the administrator receives email notifications to advise them of newly disputed items, and allow them time to research and make a determination on the dispute(s).

For returns, users may return unused materials to a holding area outside of the supply room, and the administrator will determine the salability of returned items, establishing credits and inventory adjustments as necessary. For shortages and surpluses, the System will notify the administrator when the combined weight reported for a specific shelf is not aligned with the expected quantity and weight calculation made by the System; this function highlights inventory errors and may eliminate the need for programmatic cycle counts. For put-away errors, the System will produce a daily inventory location exception report, allowing the local administrator, or supplier or customer inventory replenishment agent (CIRA), to correct the location of stock keeping units (“SKUs”) available in the supply room; whether the put-away error was by a user or a supplier, the report will alert the responsible party(ies) so that items can be correctly relocated; these System detected put-away errors will be highlighted if they are the expected cause of a cumulative weight error.

### Inventory Management Parameters

In some embodiments, the administrator can create new SKUs, edit existing SKUs, and deactivate old SKUs in the System. For editing an item, the administrator may edit descriptive attributes of existing SKUs, including adding new images, updating part numbers, and relocating products to a new shelf location in the System. SKU descriptive attributes can include at minimum of UPC, Barcode Value (e.g., Catalogue ID), Short Code, Customer Part Number, Customer Part Number (legacy), Product Manufacturer Name, Manufacturer Part Number, Supplier Item ID, Supplier Item Description, Customer Item Description, Unit of Measure (UOM), Unit Size, Unit Weight (for supply room functionality), Replenishment Values (e.g., Min/Max), Bin Location, Unit Price, Product Category, Product Sub-Category. For inventory triggers, the administrator is able to establish min/max, inventory triggers, email notification recipients, re-order quantities, and the primary supplier name per each item. For batch loading, product updates, min/max updates, shelf quantities, pricing updates, category information, and new item loading have the option to be accomplished by a standard flat file uploaded to the Inventory System, or on an individual item editing basis.

### Replenishment Process

In some embodiments, replenishment of inventory items may be performed. In some embodiments, access to the room may be controlled such that the supplier or customer inventory replenishment agent (CIRA) may be the only user of the system. The supplier's/CIRA's primary functions working within the System are to put away inventory, to add/delete items, to re-locate items, to maintain the System, and to clean the area. Put-away of replenishment inventory may be a separate function within the System, allowing the System to recognize that the user is placing specific quantities in assigned item locations (a “receiving session”). The supplier/CIRA may have the ability to look up items in the System in order to determine bin location during the put-away function. Upon completion of all put-away functions, the supplier/CIRA will confirm the System's quantity and item information gathered from the receiving session, adjusting and correcting if necessary. Upon final confirmation of quantities and items, the supplier/CIRA also has the ability to add the packing list(s) or ship-order number(s) associated with the items replenished during the session on an item or session basis; this proof of delivery information must be available when auditing receipts in the System.

The supplier or CIRA may be replenishing inventory from a remote warehouse, or the replenishment may be made from a larger inventory location in the same facility as the supply room. A separate receiving session is initiated for processing returned inventory back to the shelf. The supplier will manage returns, including determination of the salability of items and potential credits, prior to returning material to its supply room location. The System will recognize that the material was returned inventory, and during closeout of the session will give the supplier the option to enter a Returned Materials Authorization (RMA) number to establish an audit trail in the System.

### Cycle Counting Process

In some embodiments, the System can notify the administrator when the combined weight reported for a specific shelf is not aligned with the expected quantity and weight calculation made by the System. This function highlights inventory errors and will reduce the need for programmatic cycle counts. Should the client or supplier require additional cycle counting per internal SOP or accounting audit, the System will allow the administrator to create files with current on-hand quantities by bin location for cross-checking purposes. The Inventory System may support normal cycle-counting procedures, allowing the administrator to establish the time criteria for a full cycle-count driven by daily cycle-count request reports. Item transactional history is available to the administrator so that all issues, returns, receipts, and inventory adjustments can be researched to identify the reasons behind any shortage. Transactional history includes the confidence level assigned to the transaction by the System.

### System Integration Aspects

In some embodiments, the System may transmit all types of inventory transactions to the supplier's and the customer's business systems by, for example, XML document format over the internet. Standard XML documents and available transaction attributes may be specified in standard ANSI document sets, providing a format for transmitting basic transactional information from the Vision System to the Inventory System, and from the Inventory System to both supplier and customer systems. The System may also be able to receive functional acknowledgments and other updates from the supplier's and customer's business systems by XML document format over the internet. The System can transmit standardized reports of all types to administrators, suppliers, and users by email address.

### Transactional Reporting Capabilities

In some embodiments, an on-demand accounting of all products can be taken from the supply room within user-defined date parameters. The accounting may be available to both the customer's and the distributor's business systems allowing the customer to track the dollar value expensed against all cost accounting information upon issuance. The System may provide all relevant fields regarding user and product consumed, as well as all cost accounting information collected at checkout. The standard report can be organized by department and username, and then subtotaled by G/L code. The System can provide week-to-date, month-to-date and year-to-date usage figures subtotaled by cost account on the daily transaction report.

In some embodiments, a daily needs list may be sent to the distributor/supplier's business system to advise of all items that have reached a minimum quantity as of that business day (or since the last report) and should be reviewed for replenishment. The daily needs list may be sent at a predetermined frequency, such as at least once per business day, but the function can be scheduled according to the supplier's requirement, receiving the needs list either more or less frequently. The daily needs list can be sent to the supplier's business system through a purchase order by an XML formatted document. The daily needs list in some embodiments may not report items that were previously at or below the established minimum quantities and were already included on an earlier needs list. Triggers may be set by the administrator indicating percent of on-hand inventory versus minimum quantity, sending an email to the supplier to expedite these needed items. The supplier's business system may acknowledge that each item is on order with the supplier, typically through a PO acknowledgement by XML-formatted document sent back to the Inventory System. Receipt Advice Report: A daily receipt advice report will be made available to the supplier, typically through a daily Transaction Report sent by XML document to the supplier's business system. This report may confirm all items received by supplier put-away since the last report. This report will include packing list information by item delivered if this information was provided by the supplier. An on-demand report may be available to the supplier that shows those items that are outstanding on a needs list but have not yet been received, including the date of the original needs list. If the supplier has provided PO acknowledgment for an item, this information may then be included on the expediting report. The System can allow the administrator to enter monthly spend budgets by department and G/L code (or other cost accounting divisions), and then provide a separate daily transaction report, reflecting actual-to-budget consumption data.

### Downtime Reporting Capabilities

In some embodiments, the System can alert administrators and other assigned users whenever the System or a component of the System fails, either through power outage or other service loss, and also alert upon the reinstatement of service; this report is auditable by administrators. The System can alert administrators and other assigned users whenever System hardware such as a camera or a shelf scale experiences a failure, causing the System to lose information regarding transaction. This report can be auditable by administrators.

The Vision System Hardware may be configured in several embodiments. Some minimum functionalities are disclosed below, but other embodiments are possible.

### Camera Performance

In some embodiments, the cameras can be used to collect transactional data and should be able to function normally when tracking items on shelves from the floor up to at least the height of the shelving units. Cameras may be positioned at a minimum mounting height above slab. In one particular example, the cameras may be operable to track items and/or users over a height range from the floor up to 78 inches above the floor, and may be mounted at a height of approximately 102 inches, with the Secure Enclosure application driving the minimum height requirement being, for example, a special conex-type container or job trailer for which the maximum ceiling height is nine feet (108 inches).

In some embodiments, the mounting height for normal camera operation can be higher, and the standard mounting height will also be higher in the supply room enclosure environment. Standardized shelving systems have been selected for use in the supply room environment, and various sizes of standardized bins (e.g., plastic bins) can be placed on the shelves to accommodate smaller sized managed materials. Shelving units may run from the floor to a height lower than the maximum height at which the cameras can track items and/or users, for example, with a top cover installed over the top of each shelving unit. The shelves may have any suitable size, for example, the standard shelf depth may be 18 inches and the shelf width may be 36 inches. In normal operation, the cameras may collect information from the floor level up to those items housed as high as the top shelves in the supply room; other sizes of shelving may be used as client applications require. Below the top shelf, shelves can be mounted with a suitable minimum space between shelves (e.g., 6¾ inches measured from the bottom of an upper shelf to the top of the next lower shelf), depending on the types of items to be stored.

In some embodiments, the minimum aisle width for cameras may be 4 feet, or any other suitable width to accommodate user travel as well as accurate computer vision using the mounted cameras, in example embodiments. For example, in some cases lower-mounted cameras may require a wider aisle in order to effectively track users and/or items within the room.

In some embodiments, the cameras may operate normally with a lighting system capable of producing a minimum of 500 lux throughout the operational area, defined as the shelving located within the enclosure, from the floor level to shelves located at 6½ feet (seventy-eight inches) above slab, and down each aisle; light sources may be fluorescent or LED, or any other suitable lighting device, with a suitable color scale such as a cool white color scale. Cameras may also be mounted on one or more movable structures such as arms or drones, rather than a fixed mounting, in order to provide greater flexibility, coverage of a larger area, and reduced expenses associated with wiring and mounting.

### Shelf Weighing Stations

In certain embodiments, shelf weighing stations may have a low height profile (e.g., no more than ¾ inch in some embodiments) and cover the effective area of each shelf. The System works in collaboration with the measuring devices, such as weight sensors, to tare the weight of any plastic bins, and then identify the weight of dispensed or received materials held on each shelf. In certain example embodiments, the shelf weighing stations can have a weight capacity and sensitivity or accuracy appropriate to the type of items being stored and dispensed. For example, in a number of applications, a weight capacity of 200 pounds with an accuracy tolerance of plus/minus 2 grams may provide a suitable weight capacity and accuracy for a wide range of applications. Other implementations may include weight sensors having a greater or smaller weight capacity and/or a greater or smaller sensitivity, as appropriate.

The System may use item weight and quantity information to help confirm the identity of items removed from the shelf, and to identify potential inventory shortages against expected weight based upon all items on the subject shelf. The shelf weighing stations can consist of sheet metal construction in the size of the shelf in use, within which are located load cells to measure weight changes exerted upon the rectangular station; the weighing station load cell signals may be received and amplified by a local processor per shelving unit, which in turn are processed by a processor capable of managing the signals from the shelving units; the second processor (which powers the weighing stations and smaller processors) can further be connected to the local server running the Vision System. In some embodiments, the weight sensors can have a low profile, such as less than an inch, ¾″, or less, such that in an example shelving unit where the minimum shelf opening is 6¾″ in height, and the effective minimum vertical opening with a weighing station may still be approximately 6 inches.

### Entry Security

In certain embodiments, the System may give access to the supply room by unlocking the door to the enclosure when proper user credentials are presented to the System. The System may be capable of opening and closing the door for each user in order to monitor the beginning of a user session. The system will accommodate unique user identification codes via electrical proximity, punch-key, bar code, magnetic stripe sensor signals, or other similar techniques, in order to unlock the door and start the session. In an example embodiment of the disclosure, the access process utilizes a security access system proximity card reader with a 1,000-user capacity per doorway. Alternatively, the System can provide facial recognition and vocal recognition systems to unlock the door and provide access to the System. The System can allow for manual emergency exit of the supply room, including in the event of electrical power outage; should the user use the emergency exit system, an alarm may sound. The System may notify administrators and other specified users should the system observe a “man down” situation within the enclosure, and again, an alarm may sound.

### System Wiring

In some embodiments, wiring and termination boards associated with the System, including camera cabling, shelf weighing stations, and monitors, can be designed to fit into a 2″×2″ wireduct when practical, or alternatively no larger than a 4″×4″ wireduct. Wireduct can primarily be mounted either along the backside or above the top of the shelving System's vertical posts. For installation purposes, wiring schematics with suggested wireduct location can be provided to simplify the implementation process.

### Sizes and Product Capacity of Exemplary Standard Units

In some embodiments, one or more standard sizes of supply units may be offered. Although several particular example unit sizes will be described, the present technology can equally be applied to units having different sizes with any dimension being longer or shorter than any of the example dimensions described below. The various unit sizes can be expanded as modules so that the standard unit can accommodate multiples of the shelving and product counts associated with a single unit.

A first unit may size have a height, width, and length of about 10 feet (100 square feet). Shelving can include 6 (six) standard 36″×84″ units in rows of three on either side, and 2 (two) 36″×84″ shelving units opposite the doorway. The estimated industrial product capacity for the first unit size is 246 to 820 items.

A second unit size may have a height of about 10 feet and may have a width and length of about 16 feet (256 square feet). Shelving can include 14 (fourteen) standard 36″×84″ shelving units in rows of five on either side and a double row of four units down the middle. The estimated industrial product capacity is about 636 to 2,120 items.

A third unit size may have a height of about 10 feet, with a width of about 20 feet, and a length of about 30 feet (600 square feet). Shelving can include 42 (forty-two) standard 36″×84″ units in rows of six on either side and six rows of five, back-to-back down the middle. The estimated industrial product capacity is about 1,608 to 5,360 items.

A fourth unit size may have a height of about 10 feet (camera mounting height 108 inches), width of 8 feet, length of 20 feet (160 square feet). Shelving can include 11 (eleven) standard 36″×84″ units in rows of six and five (making space for door) on either side. The estimated industrial product capacity is about 564 to 1,880 items.

In certain embodiments, custom supply room designs may be available. The basic design of any customized shape or size of supply room will dictate a uniquely engineered number of cameras, camera placements, shelving layouts, and other criteria; the System can be designed to manage materials in a customized setting, leveraging all aspects of the Vision System, Inventory System, and other components. Large warehouse applications, generally in excess of 10,000 square feet, will allow the integration of other components not associated with the System as previously described. For the application of the System to large warehouses, the System may be integrated to Autonomous Mobile Robots (“AMRs”) through the Inventory System; with bin picking order management attachments, the AMRs may be sent throughout the larger warehouse to pick pallets and bins without the aid of the Vision System component. The AMRs may retrieve materials in bins or pallets based on hot-list orders or pre-ordered product lists from the shopper placed through the Inventory System; the actual quantities allocated to the shopper may not be confirmed until the AMRs have placed the bins in a Vision System area known as a staging area, which may be a pre-engineered size area with Secure Entry and Secure Enclosure, similar in size and scope to the General Store unit. The staging area will allow the shopper to choose the items they need from the preselected and retrieved bins, and to choose the quantities required; the Vision Systems in each staging area (typically one staging area per 5,000 square feet) may then confirm the quantities taken, the cost accounting information, and close out the order, all as described in the general use case of the System. Cameras may be mounted on drones in order to cover a large area, rather than a fixed mounting.

In some embodiments, some customized supply rooms may include at least a portion that is outdoors, such as a lay-down yard and construction sites. Again, cameras may be mounted on drones in order to cover a large area, rather than a fixed mounting.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Headings are included herein for reference and to aid in locating various sections. These headings are not intended to limit the scope of the concepts described with respect thereto. Such concepts may have applicability throughout the entire specification.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing numeric values of magnitude and/or position to indicate that the value and/or position described is within a reasonable expected range of values and/or positions. For example, if the value “10” is disclosed, then “about 10” is also disclosed. Any numerical range recited herein is intended to include all sub-ranges subsumed therein.

What is claimed is:

1. An autonomous supply room comprising:
an enclosure comprising:
a secure entryway configured to provide access to a user into the enclosure based on a user characteristic; and
at least one storage shelf within the enclosure;
a computer dispensing system comprising:
a sensor integrated to the storage shelf, the sensor configured to detect addition or removal of items to or from the shelf and to transmit one or more signals indicative of detecting addition or removal of items; and
one or more cameras configured to track movement of the user within the enclosure; and
one or more processors configured to:
receive the signals from the sensor and tracking information from the camera,
identify one or more items taken from the at least one storage shelf by the user, based on the one or more signals from the sensor and on the tracking information from the camera; and
transmit, to an inventory management system, information identifying the user and the items taken from the at least one storage shelf.
